(19) United States
(12) Patent Application Publication
(10) Pub. No.: US 2008/0108016 A1
(43) Pub. Date: May 8, 2008

(54) DENTAL PROSTHESIS

(75) Inventors: Stephan Holzner, Hohenschaftlarn (DE); Gerhard Weber, Purgen (DE)

Correspondence Address: DARBY & DARBY P.C., P.O. BOX 770, Church Street Station, New York, NY, 10008-0770, US

(73) Assignee: etkon Centrum fur dentale CAD/CAM-Technologie AG, Grafelfing (DE)

(21) Appl. No.: 11/936,222

(22) Filed: Nov. 7, 2007

(30) Foreign Application Priority Data
Nov. 7, 2006 (DE) 102006052478.0

(51) Int. Cl. A61C 13/08

(52) U.S. Cl. 433/203.1; 29/896.1; 433/229

(57) ABSTRACT

The invention relates to a dental prosthesis identification means. The invention furthermore relates to a method and a device for manufacturing a dental prosthesis, whereby in this method and device, an identification means is formed or the formation of such an identification means is possible.

The invention relates to a dental prosthesis.

Individualized dental prostheses can be manufactured in large quantities in a short time using automated production. Because each dental prosthesis has its own individually desired shape, however, it must be possible to assign the dental prostheses accurately. Assignment is done, e.g., on the basis of an order number, an ordering party, a patient or the like.

Should this assignment be lost during the production process, the dental prostheses must, as a rule, be remanufactured, which is associated with unnecessary costs and work.

In the case of hand-produced dental prostheses, there are usually no problems with the assignment, due to the single-unit production.

The object of the present invention is to modify the manufacturing process in such a way that unnecessary re-production is avoided.

This object is solved with a dental prosthesis in accordance with claim 1, a method in accordance with claim 10 and a device in accordance with claim 13.

The dental prosthesis is provided with an identification means. As a result of the attachment of an identification means to the dental prosthesis, it is easy to assign the dental prosthesis unambiguously. The identification means is fashioned in the manner whereby it unambiguously identifies a single dental prosthesis, so that each dental prosthesis can be distinguished from other dental prostheses from, for example, the same production day, week, year, location or company.

The identification means is advantageously connected to the dental prosthesis in such a manner that it is undetachable. For example, if a dental prosthesis is stored in a box or package on which the identification means is arranged, this identification means can be lost should the dental prosthesis fall out of the receptacle. In order to prevent this, the identification means is advantageously connected to the dental prosthesis in such a way that it is undetachable.

The identification means can be composed of or comprise letters, numbers, symbols such as figures or machine-readable codes or any combination thereof. Advantageous in this regard are particularly 2D codes, because these allow a high information density in a small area.

The identification means can be provided by means of colour or colouring and/or depression and/or elevation with respect to a surface of the dental prosthesis. A modified chemical structure, crystal structure or composition of the material with respect to the material surrounding the identification means can also provide the identification means.

Particularly advantageous is such an identification means that withstands treatment of the dental prosthesis at a temperature of at least 1,000° C. or higher levels. In this way, it is possible to provide a ceramic dental prosthesis with the identification means before the firing or dense sintering of the dental prosthesis, so that this identification means is still identifiable even after the firing or sintering process. With such an identification means, no particular monitoring of the arrangement or tracking of the arrangement in the oven needs to be followed, because the dental prostheses can be arranged in any order in the oven. As a result of the identification means, they can always be unambiguously identified, even after the firing process.

The identification means can be printed on and/or glued on and/or engraved on with a tool, such as a milling machine, and/or placed on or in the dental prosthesis by means of a laser treatment. In the event the identification means is printed on, preferably an ink or a colouring substance is used that is temperature-resistant during firing, as explained above. The engraving relates to both the deepening of the surface by means of etching or milling as well as leaving an elevation standing. Such identification means are particularly advantageous, because the identification means is directly connected to the dental prosthesis.

A laser treatment (laser labelling) in which the most focussed laser beam possible places an identification means on to or into the dental prosthesis is also advantageous. In this case, the chemical composition of the material or the crystal structure is changed locally, for example by means of a local heating of the chemical composition of the material, which leads to visual recognisability or other recognisability of the identification means. By means of a laser treatment, an easily recognisable, temperature-resistant graphite or carbon layer can also be produced on the dental prosthesis material by means of carbonisation of, e.g., dust or (oil) vapours.

The identification means can be placed on to the interior and/or exterior side of the dental prosthesis. Particularly advantageous in this case is, for example, a depression on the interior side to represent the identification means, because this identification means is no longer visible after the dental prosthesis has been put into place, and is actually filled with, for example, adhesive or cement that is used for fixing the dental prosthesis in place. An identification means on the exterior side that represents a depression or elevation is also possible.

An identification means on the exterior side is, as a rule, easier to recognise than an identification means on the interior side, where it can only be visually accessed with difficulty.

Particularly advantageous is an identification means that is arranged on a tab of the dental prosthesis, whereby this tab is advantageously formed in a single piece with the dental prosthesis. Such a tab can, for example, be produced at the same time of a milling process or 3D laser lithography.

In particular, it is advantageous when this identification means, such as the tab, can be removed without tools. In this way, a tab produced in a milling process can be removed by breaking it off. It may still be necessary to rework such a break point, which is, however, associated with low expenditures as a rule. An identification means which can be broken off is also undetachable in the above context.

In the method, a dental prosthesis is produced by means of shaping. The shaping can take place, for example, by means of milling, 3D laser lithography or the like. During the shaping of the dental prosthesis or immediately after, the identification means is formed. If the identification means is, for example, produced by means of milling the dental prosthesis or by means of 3D laser lithography, in which process a portion is left standing or a depression is engraved in, the identification means is formed during the shaping of the dental prosthesis. If, however, e.g., first the dental prosthesis is milled or otherwise shaped and then the identification means is put into place with a laser, this takes place immediately afterwards.

In this case, it is particularly advantageous if the dental prosthesis is provided with an identification means during the time that it is held in a device for shaping the dental prosthesis. If, for example, a blank is held in the milling machine and various dental prostheses are milled out of the blank, unambiguous assignment of the dental prostheses is possible for such a time as the blank with the dental prostheses or dental prosthesis is still held in the milling machine. The dental prostheses or dental prosthesis of the blank are/is consequently preferably already provided with an identification means (for example, by means of laser labelling) during the time that the blank is held.

A device for manufacturing a dental prosthesis has a first device with which a dental prosthesis can be shaped and a second device, differing from the first, with which the identification means can be formed. The first device can, for example, be a milling unit and the second device can be a laser labelling system.

Embodiments of the invention will be explained using the accompanying figures. Shown are:

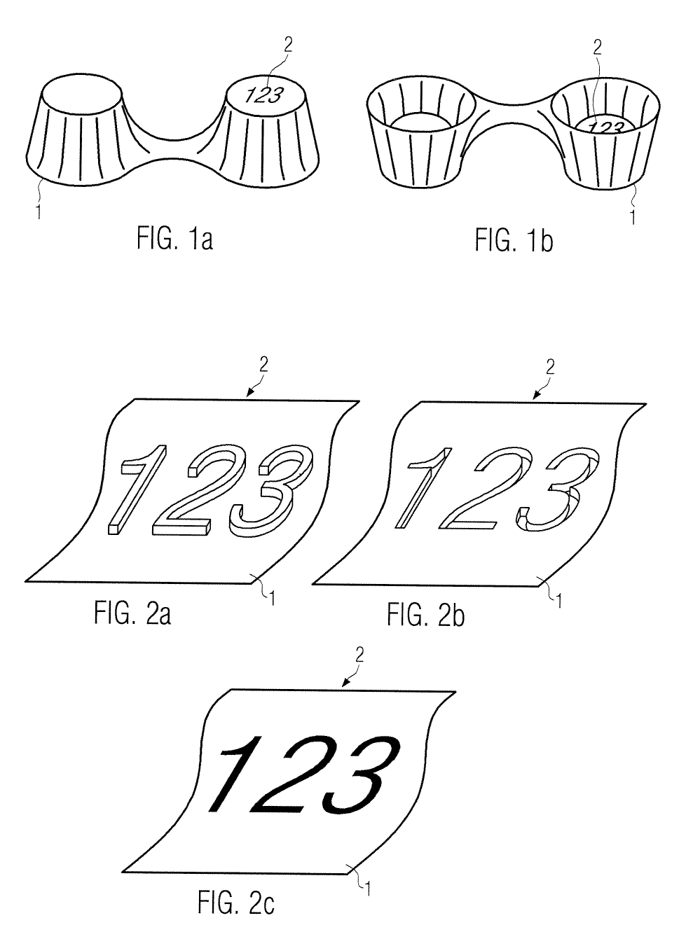

FIG. 1 a blank with an identification means;

FIG. 2 various types of identification means;

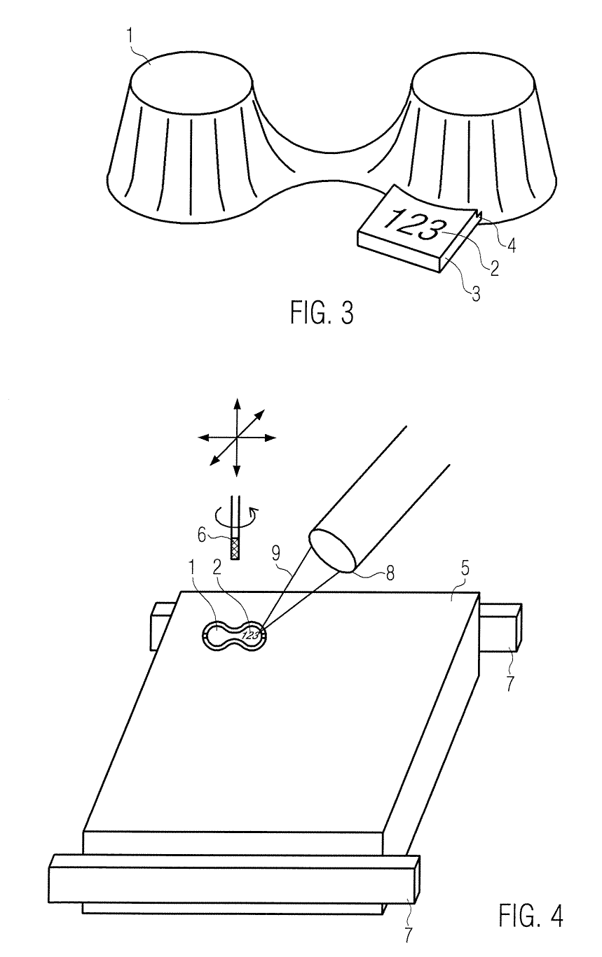

FIG. 3 a dental prosthesis with a tab with an identification means; and

FIG. 4 a schematic, three-dimensional representation of the device for manufacturing a dental prosthesis.

In FIG. 1a, a dental prosthesis 1 is shown by a bridge by way of example. The bridge has two members, but can, however, also have more members.

An identification means 2, in the form of the three numbers “1 2 3”, is placed on to the exterior or upper side of the dental prosthesis 1 in FIG. 1a. Any other form of identification means can also be provided instead of the numbers “1 2 3”.

FIG. 1b depicts the case in which the identification means is placed on the interior side of the dental prosthesis 1. The interior side is that side that faces a snag or an implant screw in the event that the dental prosthesis is inserted.

FIG. 2a depicts the case in which the identification means 2 is provided by an elevation with respect to the surface of the dental prosthesis 1.

In FIG. 2b, the numbers “1 2 3”, i.e., an identification means, are given by a depression in the surface.

FIG. 2c depicts the case of a colouring of the surface for forming the identification means.

FIG. 3 shows a case in which the dental prosthesis 1 is provided with a tab 3 that is formed as a single piece with the dental prosthesis 1. The tab 3 is connected to the dental prosthesis 1 by means of a thin targeted breaking point 4 and can be broken off without tools. During the production process and until such a dental prosthesis is deployed with the patient, the identification means 2 placed on to the tab 3 can be used for unambiguous identification of the dental prosthesis 1. The identification means can, by means of the tab 3 being broken off, be removed just shortly before the deployment of the dental prosthesis with the patient or at the time of further processing by a dental technician, for example, for covering over the dental prosthesis 1. At this time, it is, as a rule, no longer as easy to confuse one dental prosthesis with another, because there are not as many similar dental prostheses in the area.

FIG. 4 shows a blank 5 out of which a dental prosthesis 1 has been milled with a milling head (3-axis, 4-axis or 5-axis milling head). The dental prosthesis 1 is still connected to the blank 5 via bars.

The blank 5 is held with a holding device 7. With a laser labelling system 8, which is shown only symbolically, a laser beam 9 is focussed on to the dental prosthesis 1 in order to place the identification means 2 with the laser. This is preferably done while the blank 5 is still held by the holding device 7, because then the unambiguous assignment of the dental prosthesis is possible without problems.

It is also possible first to remove the blank 5 after the manufacture of the dental prostheses 1 and then arrange it separately in another system, such as a laser labelling system. In this case, however, the exact orientation of the blank must be taken into consideration, in order to give the correct dental prostheses the correct labelling. In this way, the dental prostheses still have the arrangement relative to the blank or the other dental prostheses specified by the manufacturing process.

1. Dental prosthesis with an identification means.

2. Dental prosthesis according to claim 1, wherein the identification means is connected to the dental prosthesis in an undetachable manner.

3. Dental prosthesis according to claim 1 wherein the identification means comprises at least one of the following:
one, two, three or more letters;
one, two, three or more numbers;
one, two, three or more symbols, such as geometric figures;
one, two, three or more barcodes, 2D codes or other machine readable codes.

4. Dental prosthesis according to claim 1, wherein the identification means is provided by at least one of colour, depression and elevation with respect to a surface of the dental prosthesis or by a modified chemical structure, crystal structure or composition of the material of the dental prosthesis.

5. Dental prosthesis according to claim 1, wherein the identification means is created in such a way that it is still identifiable after treatment at a temperature of at least 1,000° C., 1,100° C., 1,200° C., 1,300° C., 1,400° C., 1,500° C., 1,600° C. or 1,700° C.

6. Dental prosthesis according to claim 1, wherein the identification means is at least one of printed, glued, engraved with a tool, such as a milling machine, and placed on or in the dental prosthesis with a laser treatment.

7. Dental prosthesis according to claim 1, wherein the identification means is placed on at least one of the interior and exterior side.

8. Dental prosthesis according to claim 1, wherein the identification means is arranged on a tabs that is preferably formed as a single piece with the dental prosthesis.

9. Dental prosthesis according to claim 1, wherein the identification means can be removed without tools.

10. Method for manufacturing a dental prosthesis, in which method a dental prosthesis is shaped by means of milling or laser or 3D lithography, wherein the identification means is formed during the shaping of the dental prosthesis or after, preferably immediately after.

11. Method according to claim 10, wherein the dental prosthesis is provided with the identification means during the time that it is held in a device that holds the dental prosthesis for forming.

12. Method according to claim 10 wherein the dental prosthesis is provided with the identification means during the time that it is still held in a relative arrangement, specified by the manufacturing, with the blank from which it has been manufactured or with other dental prostheses.

13. Device for manufacturing a dental prosthesis in which a first device is provided for shaping a dental prosthesis and a second device is provided for forming an identification means.
